(19) United States
(12) Patent Application Publication
(10) Pub. No.: US 2010/0190544 A1
(43) Pub. Date: Jul. 29, 2010

(54) WAGERING GAME HAVING A COLLAPSIBLE WILD FEATURE

(75) Inventor: Alfred Thomas, Las Vegas, NV (US)

Correspondence Address: NIXON PEABODY LLP, 300 S. Riverside Plaza, 16th Floor, CHICAGO, IL, 60606, US

(73) Assignee: WMS GAMING INC., Waukegan, IL (US)

(21) Appl. No.: 12/667,066

(22) PCT Filed: Jun. 27, 2008
(86) PCT No.: PCT/US2008/007989

§ 371 Date: Dec. 29, 2009

Related U.S. Application Data
(60) Provisional application No. 60/937,812, filed on Jun. 29, 2007.

(51) Int. Cl. A63F 9/24; A63F 13/00

(52) U.S. Cl. 463/20; 463/30

(57) ABSTRACT

According to one aspect of the present invention, a gaming system includes an input device for receiving a wager to play a wagering game. The gaming system further includes a display for displaying a randomly selected outcome including a plurality of symbols forming a first array. The first array includes a plurality of rows and a plurality of columns. At least one of the rows and columns includes a first wild symbol, a second wild symbol, and at least one non-wild symbol positioned between the first and second wild symbols. The gaming system further includes a controller adapted to form a modified array on the display. The modified array includes at least one additional wild symbol positioned between the first and second wild symbols on the at least one row or column.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a wagering game having a collapsible wild feature.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

### SUMMARY OF THE INVENTION

According to one aspect of the present invention, a gaming system includes an input device for receiving a wager to play a wagering game. The gaming system further includes a display for displaying a randomly selected outcome including a plurality of symbols forming a first array. The first array includes a plurality of rows and a plurality of columns. At least one of the rows and columns includes a first wild symbol, a second wild symbol, and at least one non-wild symbol positioned between the first and second wild symbols. The gaming system further includes a controller adapted to form a modified array on the display. The modified array includes at least one additional wild symbol positioned between the first and second wild symbols on the at least one row or column.

According to another aspect of the invention, a method of conducting a wagering game the act of displaying a randomly selected outcome including a plurality of symbols forming an array. The array includes a plurality of rows and a plurality of columns in the array. The method further includes the act of, in response to one or more non-wild symbols being located between a first wild symbol and a second wild symbol on one of the plurality of rows or columns, changing the one or more non-wild symbols into additional wild symbols to form a modified array.

According to yet another aspect of the invention, a computer readable storage medium is encoded with instructions for directing a gaming system to perform the above method.

According to yet another aspect of the invention, a method of conducting a wagering game comprising the act of moving a plurality of reels with symbols thereon. The method further comprises the act of stopping the plurality of reels with symbols in a display region forming an array that indicates a randomly selected outcome of the wagering game. One of the plurality of reels includes one or more non-wild symbols located between a first wild symbol and a second wild symbol. The method further comprises the act of changing the one or more non-wild symbols into additional wild symbols on the one of the plurality of reels.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1a is a perspective view of a free standing gaming machine embodying the present invention;

FIG. 1b is a perspective view of a handheld gaming machine embodying the present invention;

FIG. 2 is a block diagram of a control system suitable for operating the gaming machines of FIGS. 1a and 1b;

FIG. 3 is an illustration of a basic game screen incorporating one embodiment of the present invention;

FIG. 4a is an illustration of a basic game screen incorporating one embodiment of the present invention after a plurality of single-symbol reels have begun to spin;

FIG. 4b is an illustration of the basic game of FIG. 4a after the single-symbol reels have stopped spinning;

FIG. 5a is an illustration of a basic game screen incorporating another embodiment of the present invention;

FIG. 5b is an illustration of a bonus game screen subsequent to the screen of FIG. 5a;

FIG. 5c is an illustration of a bonus game screen subsequent to the screen of FIG. 5b;

FIG. 6a is an illustration of a basic game screen incorporating another embodiment of the present invention after a plurality of single-symbol reels have begun to spin;

FIG. 6b is an illustration of a basic game screen subsequent to the screen of FIG. 6a;

FIG. 6c is an illustration of a basic game screen subsequent to FIG. 6b after the single-symbol reels have stopped spinning;

FIG. 6d is an illustration of a bonus game screen subsequent to the screen of FIG. 6c;

FIG. 6e is an illustration of a bonus game screen subsequent to the screen of FIG. 6d;

FIG. 7a is an illustration of a basic game screen incorporating yet another embodiment of the present invention; and

FIG. 7b is an illustration of a basic game screen subsequent to the screen of FIG. 7a.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

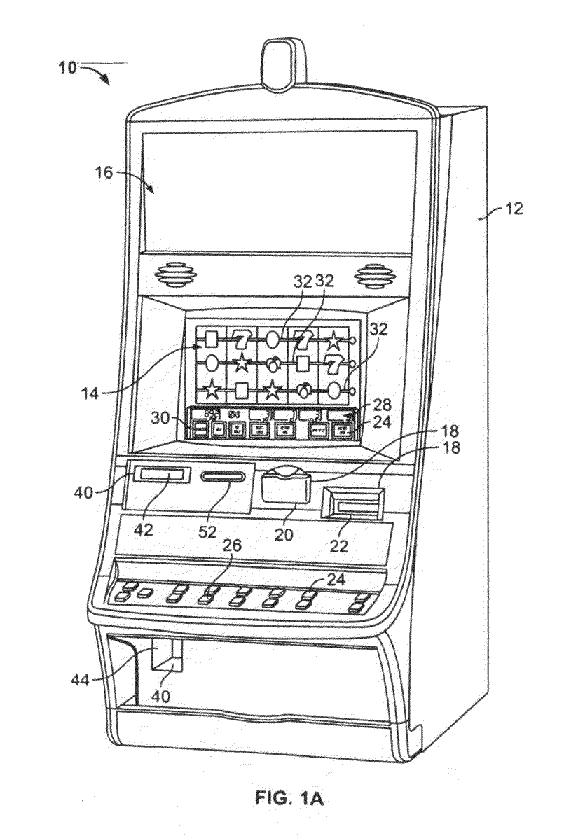

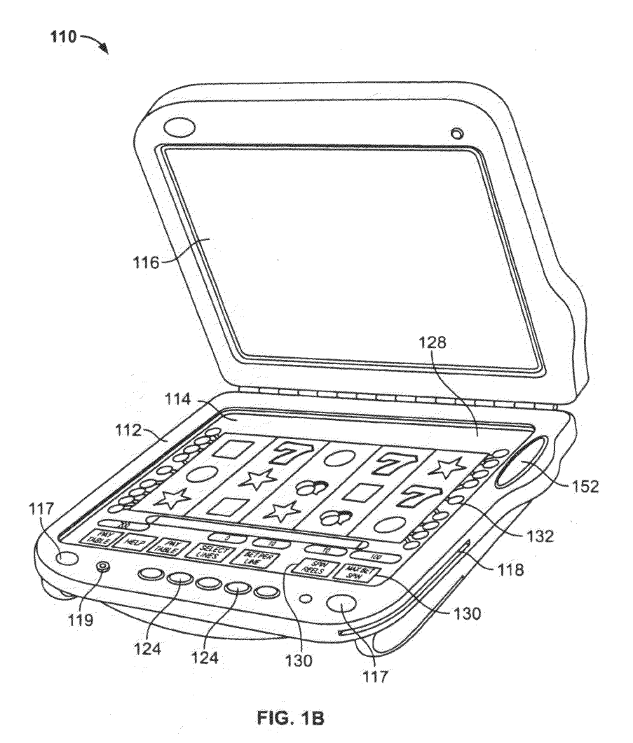

Referring to FIG. 1a, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1a). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1a, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire display (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1a as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

Depicted in FIG. 1b is a handheld or mobile gaming machine 110. Like the free standing gaming machine 10, the handheld gaming machine 110 is preferably an electronic gaming machine configured to play a video casino game such as, but not limited to, blackjack, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

The player input device 124 comprises a plurality of push buttons on a button panel for operating the handheld gaming machine 110. In addition, or alternatively, the player input device 124 may comprise a touch screen 128 mounted to a primary display 114 and/or secondary display 116. In one aspect, the touch screen 128 is matched to a display screen having one or more selectable touch keys 130 selectable by a user's touching of the associated area of the screen using a finger or a tool, such as a stylus pointer. A player enables a desired function either by touching the touch screen 128 at an appropriate touch key 130 or by pressing an appropriate push button 126 on the button panel. The touch keys 130 may be used to implement the same functions as push buttons 126. Alternatively, the push buttons may provide inputs for one aspect of the operating the game, while the touch keys 130 may allow for input needed for another aspect of the game. The various components of the handheld gaming machine 110 may be connected directly to, or contained within, the casing 112, as seen in FIG. 1b, or may be located outboard of the casing 112 and connected to the casing 112 via a variety of hardwired (tethered) or wireless connection methods. Thus, the handheld gaming machine 110 may comprise a single unit or a plurality of interconnected parts (e.g., wireless connections) which may be arranged to suit a player's preferences.

The operation of the basic wagering game on the handheld gaming machine 110 is displayed to the player on the primary display 114. The primary display 114 can also display the bonus game associated with the basic wagering game. The primary display 114 preferably takes the form of a high resolution LCD, a plasma display, an LED, or any other type of display suitable for use in the handheld gaming machine 110. The size of the primary display 114 may vary from, for example, about a 2-3″ display to a 15″ or 17″ display. In at least some aspects, the primary display 114 is a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 114 and/or secondary display 116 may have a 16:9 aspect ratio or other aspect ratio (e.g., 4:3). The primary display 114 and/or secondary display 116 may also each have different resolutions, different color schemes, and different aspect ratios.

As with the free standing gaming machine 10, a player begins play of the basic wagering game on the handheld gaming machine 110 by making a wager (e.g., via the value input device 18 or an assignment of credits stored on the handheld gaming machine via the touch screen keys 130, player input device 124, or buttons 126) on the handheld gaming machine 110. In at least some aspects, the basic game may comprise a plurality of symbols arranged in an array, and includes at least one payline 132 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the player-accessible value input device 118 of the handheld gaming machine 110 may double as a player information reader 152 that allows for identification of a player by reading a card with information indicating the player's identity (e.g., reading a player's credit card, player ID card, smart card, etc.). The player information reader 152 may alternatively or also comprise a bar code scanner, RFID transceiver or computer readable storage medium interface. In one presently preferred aspect, the player information reader 152, shown by way of example in FIG. 1b, comprises a biometric sensing device.

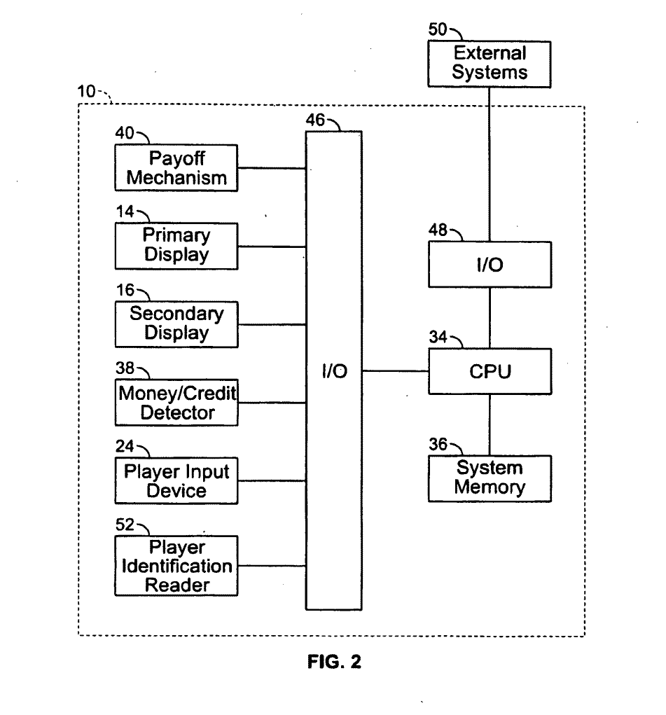

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1a, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36. The controller 34 may reside partially or entirely inside or outside of the machine 10. The control system for a handheld gaming machine 110 may be similar to the control system for the free standing gaming machine 10 except that the functionality of the respective on-board controllers may vary.

The gaming machines 10,110 may communicate with external systems 50 (in a wired or wireless manner) such that each machine operates as a “thin client,” having relatively less functionality, a “thick client,” having relatively more functionality, or through any range of functionality therebetween (e.g., a “rich client”). As a generally “thin client,” the gaming machine may operate primarily as a display device to display the results of gaming outcomes processed externally, for example, on a server as part of the external systems 50. In this “thin client” configuration, the server executes game code and determines game outcomes (e.g., with a random number generator), while the controller 34 on board the gaming machine processes display information to be displayed on the display(s) of the machine. In an alternative “rich client” configuration, the server determines game outcomes, while the controller 34 on board the gaming machine executes game code and processes display information to be displayed on the display(s) of the machines. In yet another alternative “thick client” configuration, the controller 34 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 10,110 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

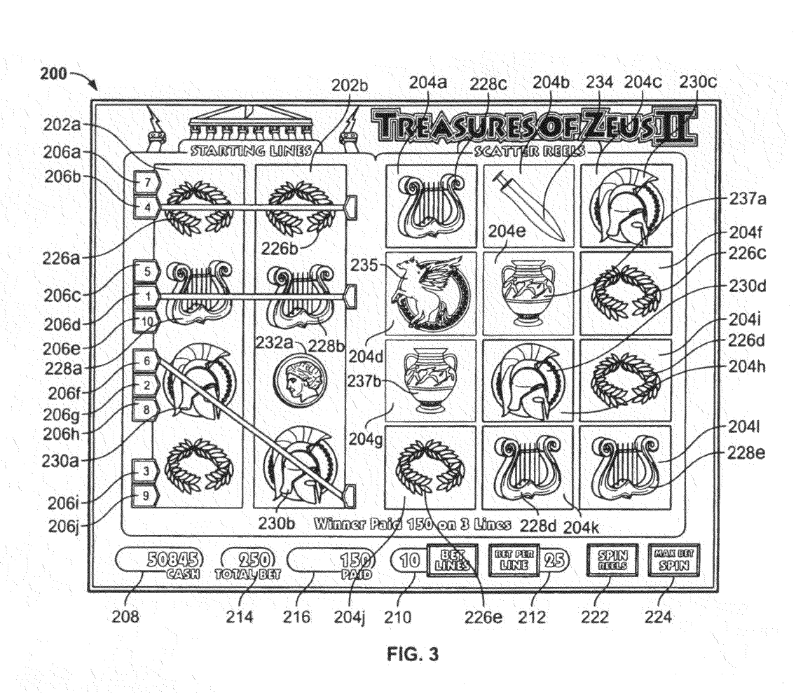

Turning now to FIG. 3, an image of a main game screen 200 according to one embodiment of the present invention is illustrated. A player begins play of a basic wagering game by inserting a wager into the value input device 18 of the gaming machine 10. A player can select play by using the player input device 24, via the buttons 26 or the touch screen keys 30, which are shown in FIGS. 1-2. The CPU 34 (or a controller in the wagering game control network in alternative embodiments) operates to execute a wagering game program causing the primary display 14 to display the wagering game that includes a plurality of visual elements.

The game screen 200 may be displayed on the primary display 14 or on a portion thereof. In the illustrated embodiment, the game screen 200 is used to display a plurality of simulated, movable multi-symbol reels 202a,b and movable single-symbol reels 204a-l. As shown, the reels 202a,b each display multiple symbols, while the reels 204a-l display a single symbol, as will be described in more detail below. The multi-symbol reels 202a,b are positioned such that the symbols are displayed relative to multiple paylines 206a-j.

The basic game screen 200 may also display a plurality of game session meters and various buttons selectable by a player. The game session meters include a “cash” meter 208 for displaying a number of credits available for play on the machine, a “bet lines” meter 210 for displaying a number of paylines 206a-j to be played by a player on the machine, a “bet per line” meter 212 for displaying a number of credits wagered (e.g., from 1 to 25 credits) for each of the number of paylines 206a-j played, a “total bet” meter 214 for displaying a total number of credits wagered for the particular round of wagering, and a “paid” meter 216 for displaying an amount to be awarded based on the results of the particular wager. The player-selectable buttons of the illustrated embodiment also include a “spin reels” button 222 for moving the reels 202a,b, 204a-l and a “max bet spin” button 224 for wagering a maximum number of credits and moving the reels 202a,b, 204a-l of the wagering game. Although not shown in the embodiment of FIG. 3, the player-selectable buttons may also include a “collect” button to collect the credits remaining in the cash meter 208 and/or a “bet/line” button for changing the amount of the wager that is displayed in the bets per line meter 212. While the gaming machine 10, 110 allows for these types of player inputs, the present invention does not require them and can be used on gaming machines having more, less, or different player inputs.

In FIG. 3, two multi-symbol reels 202a,b and twelve single-symbol reels 204a-l are illustrated. However, there may be more or less multi-symbol reels 202 and single-symbol reels 204 in accordance with the embodiments of the present invention. Furthermore, while each multi-symbol reel 202a,b displays four symbols, it is contemplated that more or less symbols may be displayed on the multi-symbol reels 202a,b. Additionally, though each of the single-symbol reels 204a-l displays only a single symbol while at rest, it should be noted that each of the single-symbol reels 204a-l include a plurality of symbols capable of being displayed thereon.

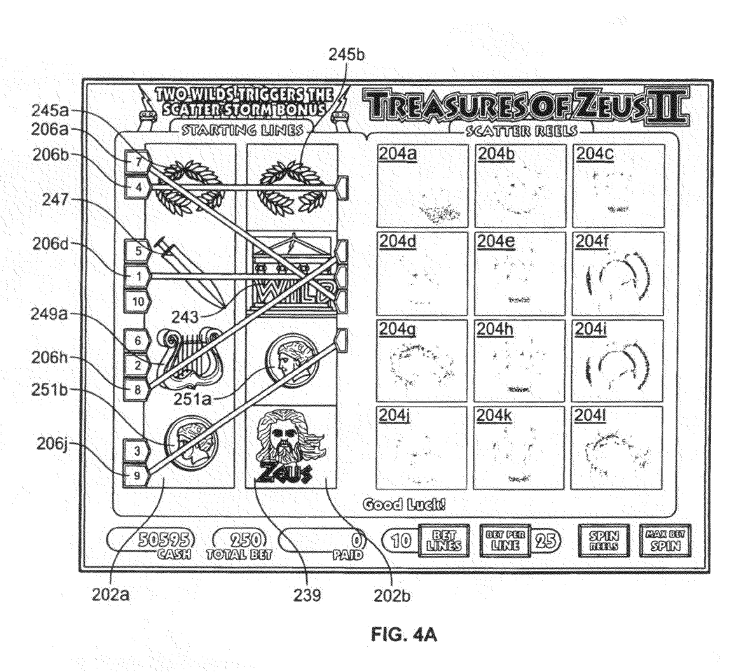

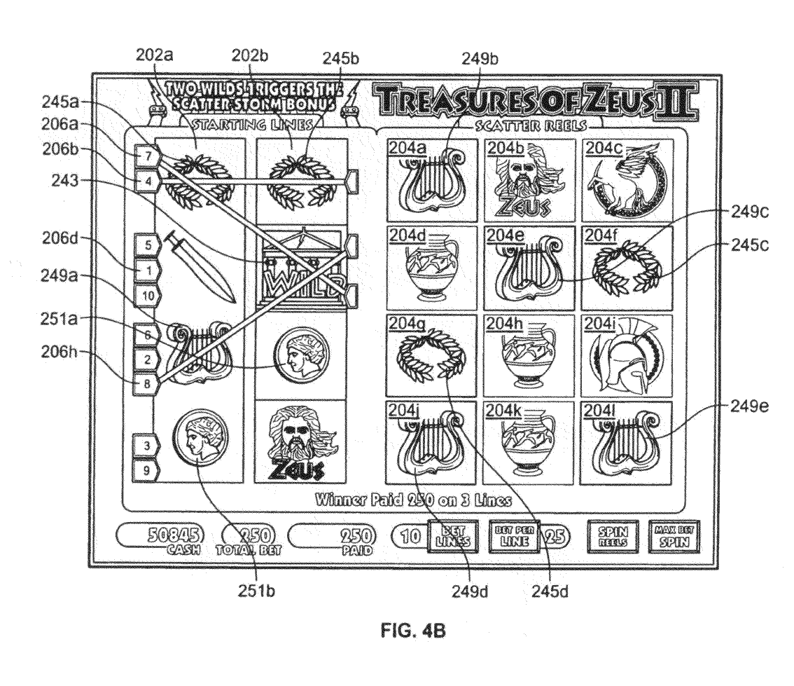

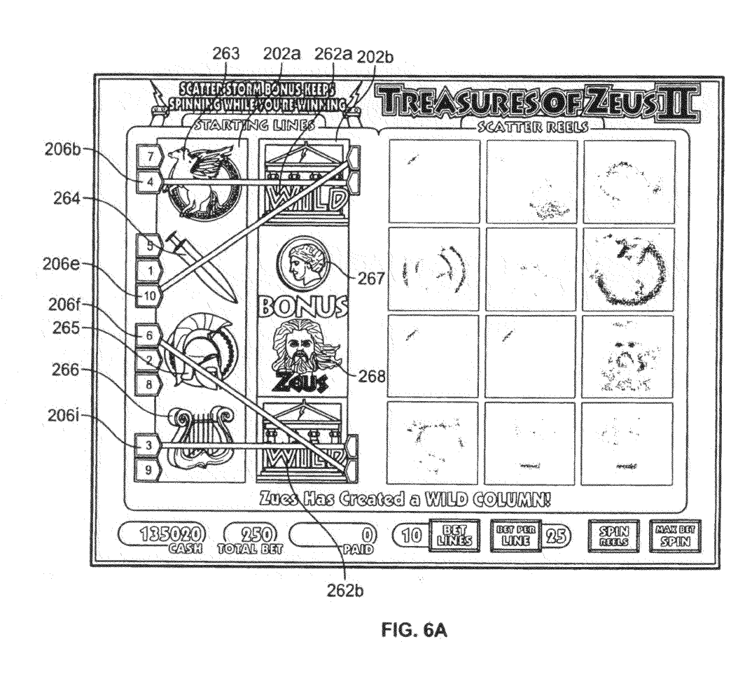

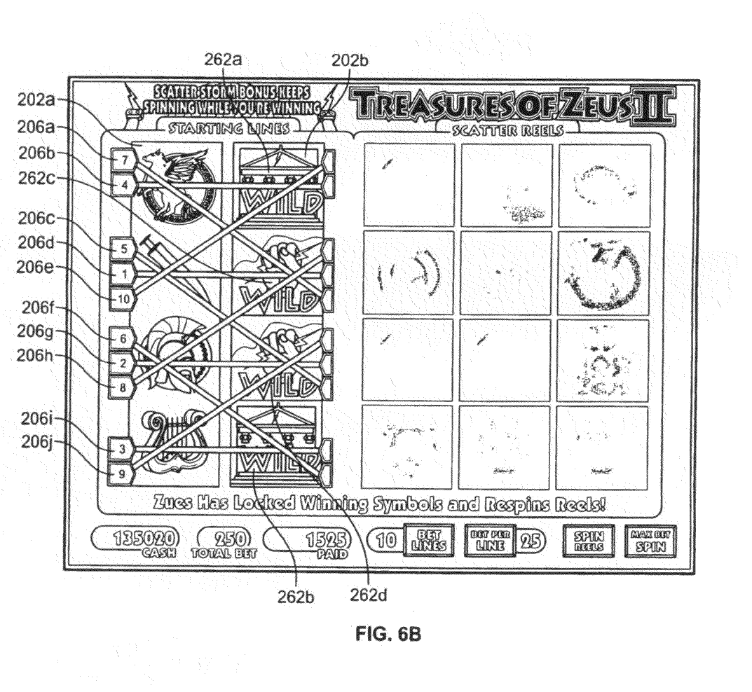

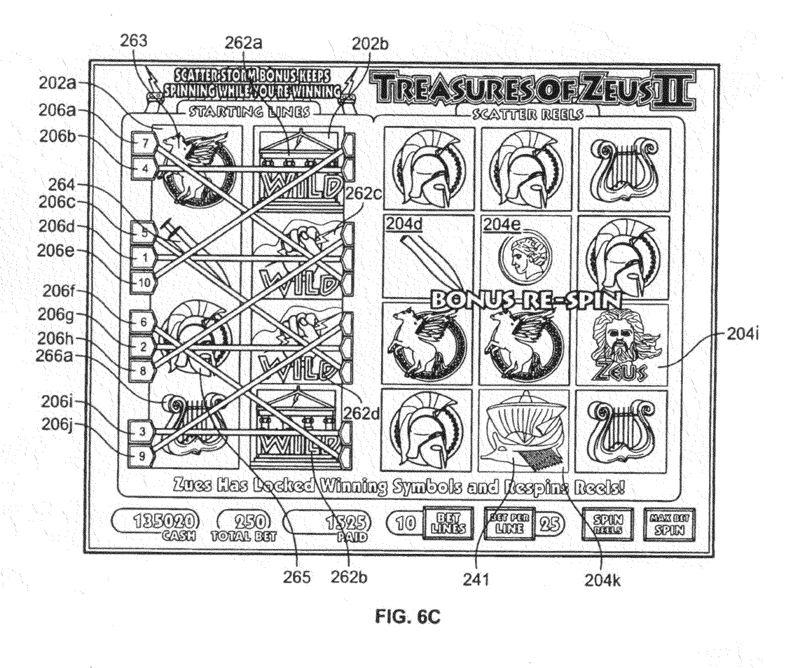

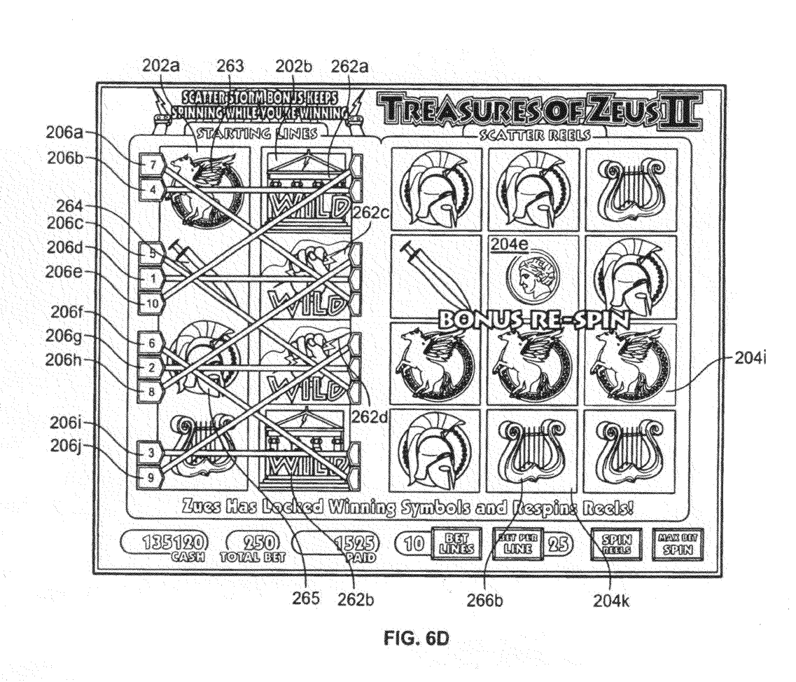

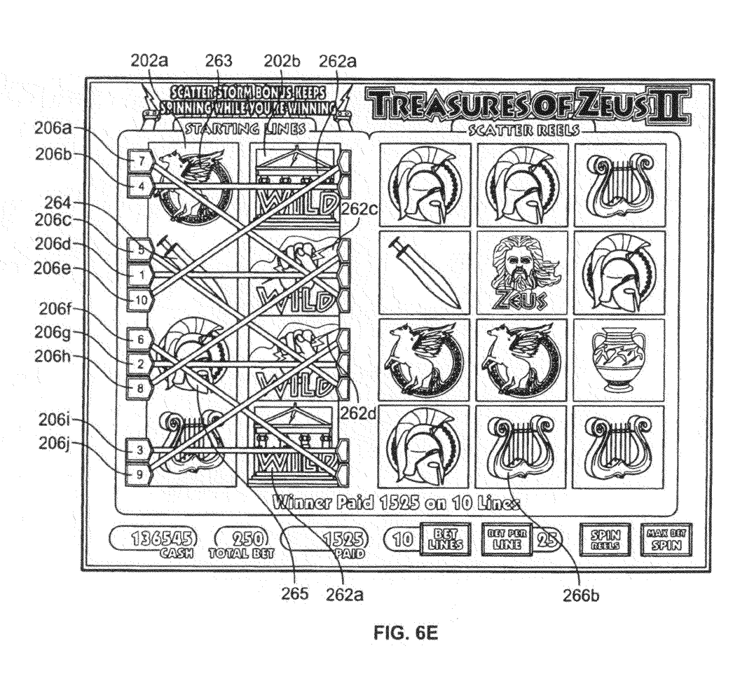

The plurality of symbols displayed on the multi-symbol reels 202a,b are used to indicate a plurality of possible outcomes along the paylines 206a-j. The depicted symbols all correspond to a “TREASURES OF ZEUS II” theme and include: “WREATH” symbols 226; “HARP” symbols 228; “HELMET” symbols 230; “COIN” symbols 232; “SWORD” symbols 234; “PEGASUS” symbols 235, “VASE” symbols 237, “ZEUS” symbols 239 (see FIG. 4a), and “SHIP” symbols 241 (see FIG. 6c).

Other TREASURES OF ZEUS-themed symbols may also be depicted. In other embodiments of the present invention, the gaming machine 10, 110 may portray other themes with corresponding like-themed symbols. Further, standard gaming symbols such as “1-BAR” symbols, “2-BAR” symbols, “3-BAR” symbols, “CHERRY” symbols, “SEVEN” symbols, “BELL” symbols, or the like may be depicted on the reels 202a,b, 204a-l in other embodiments. The multi-symbol reels 202a,b and the single-symbol reels 204a-l displaying these symbols may be either traditional mechanical reels or they may be video reels having computer-generated images. The video reels may simulate movement of the symbols positioned on the reels.

The wagering game of one embodiment of the present invention includes a hybrid-outcome payout scheme. The hybrid outcome payout scheme requires a portion of a winning outcome to be part of a payline activated by a player's wager and the remaining portion of the winning outcome to be a part of a scatter outcome. Thus, referring to FIG. 3, winning outcomes may include like-symbol combinations including symbols positioned along an activated payline 206a-j of the multi-symbol reels 202a,b and symbols in scattered positions anywhere on the single-symbol reels 204a-l. Winning like-symbol combinations are listed in a pay table, which is typically stored in the system memory 36 of the gaming machine 10, 110. The pay table may also be displayed on the secondary display 16, the primary display 14, or both and may be displayed constantly, intermittently, or upon request by a player. Winning outcomes listed in the pay table may include a three like-symbol combination yielding a first payout, a four like-symbol combination yielding a second, larger payout, a five like-symbol combination yielding a third, even larger payout, etc.

Once a player has placed a wager, the player may select the spin reels button 222. Once the spin reels button 222 has been selected, the multi-symbol reels 202a,b and the single-symbol reels 204a-l begin to move (e.g., spin). The multi-symbol reels 202a,b then come to rest and display symbols indicating a portion of a randomly selected outcome. If a symbol on the first multi-symbol reel 202a is positioned adjacent to a like-symbol on the second multi-symbol reel 202b, a corresponding payline 206a-j is activated. As illustrated in FIG. 3, two adjacent WREATH symbols 226a,b activate the horizontal payline 206b, two adjacent HARP symbols 228a,b activate the horizontal payline 206d, and two adjacent HELMET symbols 230a,b activate the diagonal payline 206f.

After the symbols of the single-symbol reels 204a-l come to rest, symbols on the single-symbol reels 204a-l that match the symbols of the activated paylines 206a-j of the multi-symbol reels 202a,b become engaged. Thus, three WREATH symbols 226c-e, three HARP symbols 228c-e, and two HELMET symbols 230c-d positioned on the single-symbol reels 204a-l become engaged. In the embodiment of FIG. 3, the engaged symbols 226c-e, 228c-e, 230c,d appear brighter than non-engaged symbols 234, 235, 237a-b, which are darkened. In some embodiments, all of the single-symbol reels 204a-l are darkened while spinning and are brightened if the symbol displayed when the single-symbol reel 204a-l comes to rest is engaged.

The resulting randomly selected outcome indicated by the symbols on the multi-symbol reels 202a,b and the single-symbol reels 204a-l is then evaluated to determine whether any winning outcomes have occurred. Winning outcomes may include any number of like-symbols appearing in a hybrid outcome. A winning outcome may, therefore, include between three and fourteen total like-symbols. The outcome of FIG. 3 includes three winning outcomes: a five-WREATH symbol 226a-e combination, a five-HARP symbol 228a-e combination, and a four-HELMET symbol 230a-d combination.

In some embodiments, the single-symbol reels 204a-l spin and stop only if at least one payline 206a-j is activated on the multi-symbol reels 202a,b by two like-symbols. Furthermore, although in the embodiment described, the single-symbol reels 204a-l spin simultaneously with the multi-symbol reels 202a,b, the single-symbol reels 204a-l may spin prior to or after the multi-symbol reels 202a,b spin. In an alternative embodiment, the single-symbol reels 204a-l are constantly spinning, and only stop and display reel symbols if at least one payline 206a-j on the multi-symbol reels 202a,b is activated.

The payouts for various winning like-symbol combinations may vary. For example, as the number of like-symbols in a winning combination increases, the payout generally increases accordingly. In some embodiments, the award may increase exponentially as the number of like-symbols in a winning combination increases. Furthermore, certain symbols may be ranked higher than others such that a payout for a winning combination of higher-ranked symbols may be greater than the payout for a winning combination including the same quantity of lower-ranked symbols. For example, a payout for the five-WREATH symbol 226a-e combination may be greater than a payout for the five-HARP symbol 228a-e combination. Such rankings and corresponding differing payouts may reflect the likelihood of achieving a particular winning outcome.

In some embodiments, a fewer number of higher-ranked symbols yields a smaller payout than a greater number of lower-ranked symbols. In such embodiments, it would be desirable for paylines 206a-j including lower-ranked symbols to be activated on the multi-symbol reels 202a,b, since the lower-ranked symbols are more likely to appear on the single-symbol reels 204a-l.

Turning now to the embodiment of FIG. 4a, one or more of the multi-symbol reel 202a,b may include one or more “WILD” symbols 243. A WILD symbol 243 activates the paylines including the WILD symbol 243 and symbols positioned adjacent to the WILD symbol 243. For example, the WILD symbol 243 positioned in the second multi-symbol reel 202b activates three paylines: a payline 206a including the WILD symbol 243 and an adjacent WREATH symbol 245a, a payline 206d including the WILD symbol 243 and an adjacent SWORD symbol 247, and a payline 206h including the WILD symbol 243 and an adjacent HARP symbol 249a.

Additionally, since paylines 206b,j respectively include like-WREATH symbols 245a,b and like-COIN symbols 251a,b, the paylines 206b,j are also activated.

As shown in FIG. 4b, when the single-symbol reels 204a-l of FIG. 4a come to rest, the randomly selected outcome of the game may be evaluated. In the embodiment shown, although five paylines 206a,b,d,h,j were originally activated, paylines 206d,j do not form winning outcomes at the conclusion of the spin because matching symbols did not appear on the single-symbol reels 204a-l (i.e., no SWORD symbols or COIN symbols were displayed on the single-symbol reels 245a-l). Additional WREATH symbols 245c,d and additional HARP symbols 249b-e appeared on the single-symbol reels 202a-l, and, thus, the paylines 206a,b,h including the WREATH symbols 245a,b and the HARP symbol 249a form winning outcomes. In some embodiments, the WILD symbol 243 is included in determining the quantity of symbols in the winning like-symbol combinations. Thus, in the embodiment of FIG. 4b, the player may receive a payout corresponding with a five-symbol WREATH combination (i.e., four WREATH symbols 245a-d and one WILD symbol 243) and a six-symbol HARP combination (i.e., five HARP symbols 249a-e and one WILD symbol 243).

The wagering game may also include a bonus respin event in which non-winning reels—i.e., reels that do not include winning symbols forming part of a winning outcome—are respun. Thus, additional winning outcomes or larger symbol combinations may be achieved during the respin.

The amount of respins may be determined in various ways. For example, the non-winning reels may respin until either (a) all of the symbols on all of the reels 202a,b, 204a-l form part of a winning outcome(s) or (b) an additional winning outcome (i.e., new or larger winning like-symbol combinations) is not achieved.

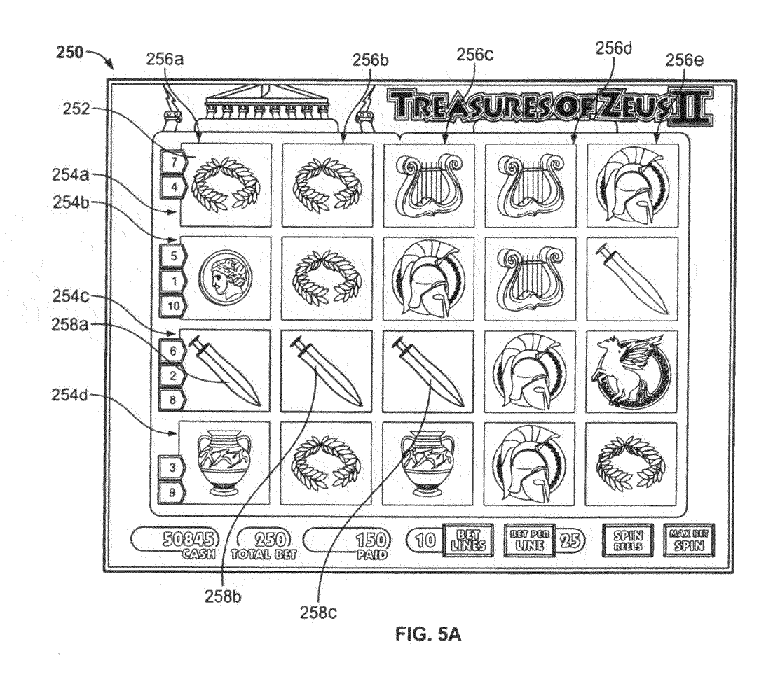

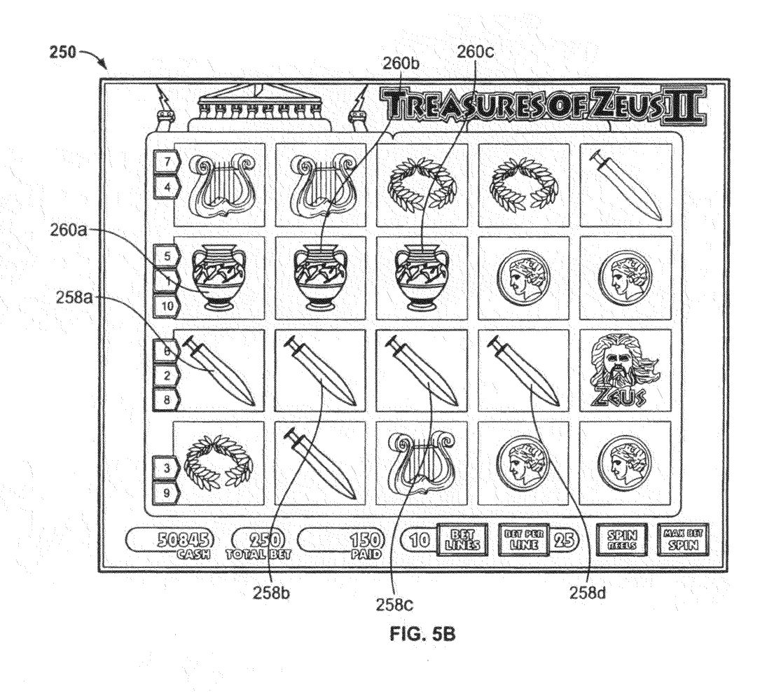

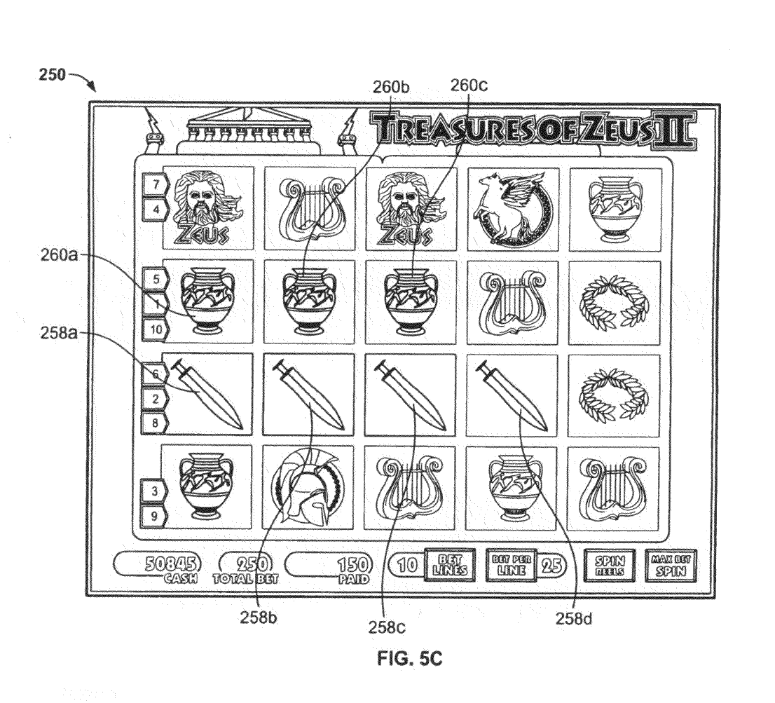

FIGS. 5a-c illustrate the respin feature with respect to a standard array 250 of single-symbol reels 252. The array 250 includes four rows 254a-d and five columns 256a-e. In other embodiments, the array 250 may include multi-symbol reels, a combination of single-symbol reels and multi-symbol reels, a different number of rows and/or columns, or the like. The outcome of a first spin is illustrated in FIG. 5a. The outcome includes a winning symbol combination comprising three adjacent SWORD symbols 258a-c.

As a result of a winning outcome being achieved in the first spin, the non-winning reels are respun. Thus, all of the reels 252 except those displaying the winning SWORD symbols 258a-c are respun. The outcome of the respin, illustrated in FIG. 5b, includes an additional winning outcome including three adjacent VASE symbols 260a-c. The respin also resulted in a second winning outcome including a fourth SWORD symbol 258d positioned adjacent to the winning SWORD symbols 258a-c of the first spin. The second winning outcome, thus, increased the quantity of SWORD symbols in the winning symbol combination of FIG. 5a, thereby providing a higher payout.

Because at least one additional winning outcome was generated during the respin, the remaining non-winning reels 252 are spun yet again. The result of the second respin is illustrated in FIG. 5c. No additional outcomes were generated in the second respin, and, thus, the game ends and a payout corresponding with the winning outcomes of three adjacent VASE symbols 260a-c and four adjacent SWORD symbols 258a-d is awarded.

The respin feature or other bonus event may be triggered in a variety of ways. In one aspect, the respin feature may be symbol-triggered by one or more of the reels including, for example, a “RESPIN” symbol. During the respin, the triggering symbol may be held (i.e., not spun) or respun. The respin feature or bonus event may also be triggered by a winning outcome, all of the symbols on the reels being part of a winning outcome, a random trigger, reasons unbeknownst to the player (e.g., mystery trigger), or the like. Other types of bonus events that may be triggered include, but are not limited to additional credits, certain bonus games, other free spin events, top box bonuses, trail game bonuses, and all other kinds of bonus games. In some embodiments where the bonus event is triggered by a winning symbol combination including a predetermined quantity of like-symbols, the difference between the quantity of like-symbols achieved and the predetermined quantity of symbols may correspond with a multiplier used to increase a payout or award. For example, if three matching symbols are required to trigger a respin or bonus event, achieving four matching symbols may result in a 2× multiplier, achieving five matching symbols may result in a 3× multiplier, achieving six matching symbols may result in a 4× multiplier, etc.

According to another embodiment of the present invention, the wagering game includes a collapsible wild feature, which is activated when more than one WILD symbol appear in non-adjacent positions on a single reel, row, or column. When the collapsible wild feature is activated, all of the symbols positioned between the WILD symbols become wild. Because the WILD symbols may appear on a single column or a single row, the “collapse” may be vertical or horizontal.

Referring to FIGS. 6a-c, for example, WILD symbols 262a,b are positioned on a top and bottom of the second multi-symbol reel 202b. Because two symbols (i.e., PEGASUS symbol 263 and SWORD symbol 264) of the first multi-symbol reel 202a are adjacent to the top WILD symbol 262a, a corresponding two paylines 202b,e are activated. Likewise, the paylines 206f,i including the two symbols (i.e., HELMET symbol 265 and HARP symbol 266a) of the first multi-symbol reel 202a adjacent to the bottom WILD symbol 262b are activated. The collapsing wild feature causes the symbols positioned between the WILD symbols 262a,b (e.g., COIN symbol 267 and ZEUS symbol 268) to become WILD symbols 262c,d, as shown in FIG. 6b. When a collapse occurs, all of the paylines 206a-j are necessarily engaged. Because four different types of symbols (i.e., PEGASUS symbols, SWORD symbols, HELMET symbols, and HARP symbols) corresponding with the activated paylines 206a-j may be engaged on the single-symbol reels 204a-l, there is a relatively high likelihood that a large quantity of symbols on the single-symbol reels 204a-l will form a part of a winning outcome(s).

Symbols located in the middle positions of the first multi-symbol reel 202a (i.e., SWORD symbol 264 and HELMET symbol 265) are each associated with three activated paylines (i.e., paylines 206c-e and paylines 206f-h respectively), while symbols located in the top and bottom positions of the first multi-symbol reel 202a (i.e., PEGASUS symbol 263 and HARP symbol 266a) are each associated with only two paylines (i.e., paylines 206a,b and paylines 206i,j respectively). Thus, it is likely that a higher payout may be achieved for winning like-symbol combinations including symbols in the middle positions of the first multi-symbol reel 202a.

FIG. 6c illustrates the game of FIGS. 6a,b after the multi-symbol reels 204a-l have stopped spinning. Only three of the independent reels 204e,i,k do not form part of a winning outcome. In the illustrated embodiment, when a collapse occurs on the second multi-symbol reel 202b, an automatic respin, as shown in FIGS. 6c-e and as described above, is awarded. Thus, the non-winning reels 204e,i,k are respun while the winning reels 204a-d,f-h,j,l are held (i.e., not spun). The respin process continues until all of the symbols on the single-symbol reels 204a-l form part of a winning like-symbol combination or until no additional winning outcomes are achieved. As shown in FIG. 6d, the first respin results in an additional winning symbol—HARP symbol 266b. The presence of a new winning symbol in the respin causes the non-winning symbols on the single-symbol reels 204e,i to spin yet again. As shown in FIG. 6e, the second respin did not result in any additional winning symbols or outcomes. Thus, the game ends, and awards corresponding with the winning outcomes are awarded to the player.

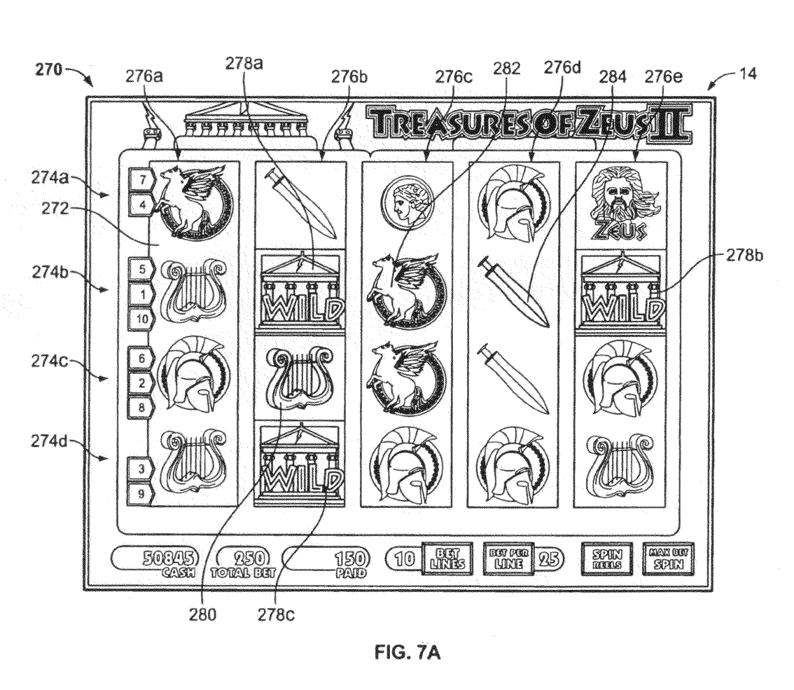

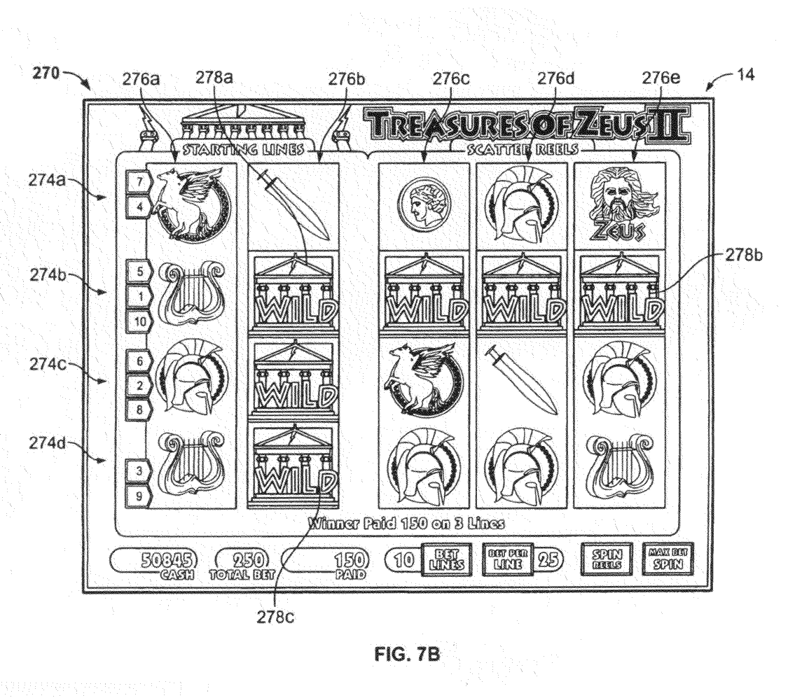

The collapsible wild feature may be applied to wagering games other than those illustrated herein. FIGS. 7a,b, for example, illustrated the collapsible wild feature being implemented on a standard slot machine according to one embodiment. The display 14 displays an array of multiple-symbol reels 272 forming four rows 274a-d and five columns 276a-e. As shown in FIG. 7a, the outcome of a first spin includes three WILD symbols 278a-c. The presence of more than one, WILD symbol in a single row and/or column activates the collapsible wild feature.

The collapsible wild feature causes the symbol (i.e., HARP symbol 280) positioned between the WILD symbols 278a,c of the second column 278b to become wild and the symbols (i.e., PEGASUS symbol 282 and SWORD symbol 284) positioned between the WILD symbols 278a, 278b of the second row 274b to become wild, as shown in FIG. 7b. The array 270 may then be evaluated to determine winning outcomes.

The collapsible wild feature may be implemented on computer-generated images of reels or on traditional mechanical reels. In embodiments where the reels are mechanical, a transmissive display may be used over the mechanical reels. The transmissive display is generally transparent until activated, at which time the player may perceive the images displayed by the transparent display over the underlying mechanical reels. The transparent display may be used to make a row, column, or portion thereof appear wild. Other examples of displaying images over mechanical reels are described in U.S. Pat. No. 6,517,433 and PCT publication WO 2007/005846, which is hereby incorporated by reference in its entirety.

Each of these embodiments and obvious variations thereof is contemplated as falling within the spirit and scope of the claimed invention, which is set forth in the following claims.

What is claimed is:

1. A gaming system comprising:
an input device for receiving a wager to play a wagering game;
a display for displaying a randomly selected outcome including a plurality of symbols forming a first array, the first array including a plurality of rows and a plurality of columns, at least one of the rows and columns including a first wild symbol, a second wild symbol, and at least one non-wild symbol positioned between the first and second wild symbols; and
a controller adapted to form a modified array on the display, the modified array including at least one additional wild symbol positioned between the first and second wild symbols on the at least one row or column.

2. The gaming system of claim 1, wherein the first and second wild symbols are positioned in a first column.

3. The gaming system of claim 2, wherein the first wild symbol is positioned in a top row of a first column of the first array and the second wild symbol is positioned in a bottom row of the first column of the first array such that all of the symbols of the first column in the modified array are wild symbols.

4. The gaming system of claim 3, wherein the modified array includes a plurality of active paylines extending through symbol positions within the modified array, the modified array including additional winning outcomes along the active paylines that were not present in the first array.

5. The gaming system of claim 4, wherein the active paylines are selected by a player from a plurality of paylines before the randomly selected outcome is displayed.

6. The gaming system of claim 1, wherein the first and second wild symbols are positioned in a first row.

7. The gaming system of claim 1, wherein the array includes a plurality of video reels formed by a video display.

8. A method of conducting a wagering game, the method comprising the acts of:
displaying a randomly selected outcome including a plurality of symbols forming an array, the array including a plurality of rows and a plurality of columns in the array; and
in response to one or more non-wild symbols being located between a first wild symbol and a second wild symbol on one of the plurality of rows or columns, changing the one or more non-wild symbols into additional wild symbols to form a modified array.

9. The method of claim 8, wherein the first and second wild symbols are positioned in a first column.

10. The method of claim 9, wherein the first wild symbol is positioned in a top row of a first column and the second wild symbol is positioned in a bottom row of the first column.

11. The method of claim 10, wherein the act of changing the one or more non-wild symbols into additional wild symbols includes changing all non-wild symbols in the first column into additional wild symbols.

12. The method of claim 8, wherein the first and second wild symbols are positioned in a first row.

13. One or more computer readable storage media encoded with instructions for performing the method of claim 8.

14. The method of claim 13, wherein the act of changing the one or more non-wild symbols into additional wild symbols includes changing all non-wild symbols in the first row into additional wild symbols.

15. The method of claim 8, further comprising activating one or more paylines extending through the modified array in response to a player selection of the one or more paylines.

16. The method of claim 15, further comprising evaluating the modified array for winning symbol combinations along the active paylines.

17. A method of conducting a wagering game, the method comprising the acts of:
moving a plurality of reels with symbols thereon;
stopping the plurality of reels with symbols in a display region forming an array that indicates a randomly selected outcome of the wagering game, one of the plurality of reels including one or more non-wild symbols located between a first wild symbol and a second wild symbol; and
changing the one or more non-wild symbols into additional wild symbols on the one of the plurality of reels.

18. The method of claim 17, wherein the first wild symbol is positioned in a top row of a first reel and the second wild symbol is positioned in a bottom row of the first reel.

19. The method of claim 18, wherein the act of changing the one or more non-wild symbols into additional wild symbols includes changing all non-wild symbols in the first reel into additional wild symbols.

20. The method of claim 17, further comprising activating one or more paylines extending through the array.
